(19) United States
(12) Patent Application Publication
(10) Pub. No.: US 2026/0204995 A1
(43) Pub. Date: Jul. 16, 2026

(54) ELECTRIC MACHINE WITH LINEAR MOVEMENT

(71) Applicant: EE-GINE, ANGERS (FR)

(72) Inventor: Frédéric STREIFF, Angers (FR)

(21) Appl. No.: 18/874,497

(22) PCT Filed: May 17, 2023
(86) PCT No.: PCT/IB2023/055096

§ 371 Date: Sep. 29, 2025

(30) Foreign Application Priority Data
Jun. 14, 2022 (FR) 2205708

(51) Int. Cl. H02K 41/02; H02K 1/08; H02K 1/18

(52) U.S. Cl. CPC H02K 41/02; H02K 1/08; H02K 1/18; H02K 2201/03; H02K 2213/09

(57) ABSTRACT

The invention relates to an electric machine (1) with linear movement, configured to function in accordance with at least one of a motor mode and a generator mode, comprising a primary assembly (3) comprising at least one stator assembly (31), a secondary assembly (4) configured to move relative to the primary assembly (3) and comprising an interaction part (41), each stator assembly (31) being disposed opposite the interaction part (41) of the secondary assembly (4), characterised in that each stator assembly (31) comprises a cylinder head (311), at least two pairs (312) of teeth (312a, 312b), connection means (313) configured to be suitable for connecting the teeth (312a, 312b) to the cylinder head (311) without deformation of the teeth (312a, 312b) or the cylinder head (311) altering the circulation of a magnetic field or increasing iron losses, and the electric machine (1) with linear movement further comprising at least one of: magnets (413, 414) disposed between the interaction sub-parts (411) of the interaction part (41) of the secondary assembly (4); and magnets (315) disposed between the teeth (312a, 312b) and the cylinder head (311) of at least one stator assembly (31).

This application is the U.S. national phase of International Application No. PCT/IB2023/055096 filed May 17, 2023, which designated the U.S. and claims priority to FR 2205708 filed Jun. 14, 2022, the entire contents of each of which are hereby incorporated by reference.

The present invention relates to the technical field of linear movement electrical machines, and more particularly relates to polyphase linear movement electrical machines with transverse magnetic flux.

The advantage of linear movement electrical machines with magnetic flux is that same do not require a mechanical power transmission device, such as a ball screw or a satellite roller screw, and hence do not generate friction between the moving parts.

Such machines have been the subject matter of many developments in the prior art.

For example, European patent application EP0352189 A1 discloses a linear movement electrical machine with transverse magnetic flux. However, this document does not propose a functional embodiment for such a machine. More particularly, same does not propose the use of so-called electrical laminated sheets to reduce eddy current losses.

French patent application FR3022708 A1 also discloses a linear movement electrical machine for which it is possible to reduce the expansion forces by offsetting one of the stators relative to the other stator along the direction of displacement. However, this document does not propose a functional embodiment of the offset making it possible to limit the air gap between the lineator and the stator so as to improve the electromagnetic performance of the machine. In addition, with a “simple” stator offset, it is not possible to reduce the expansion forces related to the manufacturing tolerances of the components forming the stator.

Therefore, the solutions of the prior art proposed for linear movement electrical machines always have drawbacks, so improvements of such systems are possible.

US9722479B2 also discloses a linear movement electrical machine.

The invention aims in particular to propose a linear movement electrical machine with transverse magnetic flux comprising stator assemblies comprising sheets stacked in a stacking direction always perpendicular to the direction of propagation of the transverse magnetic flux.

Another goal of the invention is to propose a machine comprising a small number of different sheet profiles for the stator assemblies.

Another goal of the invention is to propose a machine enabling the sheets of the stator assemblies to be secured together without drilling, screwing or deformation of the sheets, while minimizing parasitic air gaps.

Another goal of the invention is to propose a machine for which the spacings between the teeth of the stators are adjustable in order to reduce the expansion forces of the machine.

Another goal of the invention is to propose a machine comprising a secondary assembly comprising a plurality of sheets stacked in a stacking direction parallel to the direction of displacement of the secondary assembly.

Another goal of the invention is to propose a machine comprising a secondary assembly comprising at least one central cavity for limiting a magnetic short circuit in the secondary assembly.

Another goal of the invention is to propose a machine for which the air gaps between the stator assemblies and the secondary assembly are adjustable.

Another goal of the invention is to propose a machine configured to operate with a low pole pitch.

Thereby, the subject matter of the present invention is a linear movement electrical machine with linear movement in a direction of displacement, configured to operate according to at least one motor mode, in which electrical energy is transformed into mechanical energy of linear movement type in the direction of displacement, and a generator mode, in which mechanical energy of the linear movement type in the direction of displacement is transformed into electrical energy, said electrical machine comprising a primary assembly comprising at least one stator assembly configured to be fixed to a frame; a secondary assembly configured to move relatively with respect to the primary assembly in the direction of displacement, the secondary assembly comprising an interaction part within which a plurality of interaction sub-parts are distributed in the direction of displacement, and at least one shaft, which is integral with the interaction part and extends in the direction of displacement, each stator assembly being arranged opposite the interaction part of the secondary assembly; translational guide means configured to guide the relative movement of the secondary assembly with respect to the primary assembly; and an electrical module; characterized in that each stator assembly comprises a yoke which has at least two lateral contact faces, defined on either side of an axis parallel to the direction of displacement and passing through the center of the yoke; at least two pairs of teeth, each tooth having a head end configured to come into contact with a lateral contact face of the yoke and a base end, opposite the head end, configured to be oriented towards the interaction part of the secondary assembly, such that an air gap is formed between the teeth and the interaction sub-parts of the secondary assembly and that, upon relative movement of the secondary assembly with respect to the primary assembly, an interaction sub-part of the secondary assembly moves relatively parallel to the surface formed by the base ends of the teeth of the opposing stator assembly, the pairs of teeth being spaced apart along the yoke in the direction of displacement, the teeth of a pair of teeth being arranged diagonally along the yoke such that, for each pair of teeth, a first tooth is in contact with a lateral contact face of the yoke and a second tooth is in contact with another lateral contact face of the yoke, a coil surrounding each tooth around a body section between the head end and the base end, and each tooth being configured to interact magnetically with opposing interacting sub-parts of the opposing secondary assembly; securing means configured to be able to secure the teeth to the yoke, without any deformation of the teeth or of the yoke altering the circulation of a magnetic field or increasing iron losses; and fixing means configured to fix the stator assembly to the frame; the linear movement electrical machine further comprising at least one of magnets arranged between interaction sub-parts of the interaction part of the secondary assembly, and magnets arranged between the teeth and the yoke of at least one stator assembly; in motor mode, the electrical module is configured to transmit a polyphase AC supply to the coils so as to generate time-varying magnetic fields, each coil being configured and powered to generate a magnetic polarity at the base end of the tooth that it surrounds and to generate an opposite magnetic polarity at the head end of the tooth that it surrounds, and the coils of each pair of teeth being configured to generate a polarity at the base end, respectively at the head end, of the first tooth and to generate an opposite polarity at the base end, respectively at the head end, of the second tooth, so as to create a transverse magnetic loop between said first tooth, the yoke and said second tooth, and the coils of each pair of teeth being configured and powered such that the produced magnetic fields vary as a function of variations in the polyphase AC supply so as to produce a relative displacement of the secondary assembly with respect to the primary assembly; in generator mode, the electrical module is configured to recover electrical currents generated, in the coils surrounding the teeth of the primary assembly, by magnetic interactions formed between the interaction part of the secondary assembly and the teeth of the primary assembly.

The embodiment described hereinabove proposes a functional configuration for a linear movement electrical machine configured to operate in motor mode and/or in generator mode, for which the teeth of the stator assemblies are manufactured separately and then brought into contact laterally with the yokes and secured thereto, possibly in an adjustable manner, without deformation of the teeth or yokes altering the circulation of a magnetic field or increasing iron losses, unlike for example fixing by drilling or screwing, so as to allow for optimum circulation of the magnetic fluxes in the primary assembly and thus obtain a high performance electrical machine. Operation with a small pole pitch is also made possible by the distribution of the teeth along the yokes.

In one embodiment, for at least one tooth, a projected area of the base end onto the interaction part is greater than a projected area of the body section onto the interaction part.

The use of teeth for which the projected area of the base end onto the interaction part is greater than the projected area of the body section onto the interaction part makes it possible, for each tooth, to increase the surface area through which passes the magnetic flux passing through the tooth and hence the zone of interaction between the tooth and the interaction part.

The base ends of the teeth may for example have a widening which extends along a longitudinal direction of the opposing interaction sub-parts and/or along the direction of displacement.

Even with teeth having the proportions described hereinabove, the winding of the teeth is easy since, with an electrical machine according to the invention, the teeth and the yokes are independent before being secured. The teeth can thereby be freely wound before being secured to the yokes.

According to one embodiment, for at least one stator assembly, the securing means comprise at least one resin-type material configured to encapsulate the teeth on the yoke.

The use of a resin-type material for the securing means makes it possible, during assembly, to bring the head ends of the teeth into contact with the lateral contact faces of the yoke, and then, during use, to hold the teeth in position relative to the yoke by encapsulation, without any deformation of the teeth or the yoke. The magnetic performance of the machine is thereby optimized. It will also be understood that, in a variant, a resin-type material can be used to bond the head ends of the teeth to the lateral contact faces of the yoke, the teeth then not being in direct contact with the yoke.

According to a particular embodiment, for at least one stator assembly, the securing means comprise two jaws, arranged on either side of the yoke, configured to secure the teeth to the yoke, each jaw comprising at least one plate, a first jaw being intended to receive the first teeth of the pairs of teeth and a second jaw being intended to receive the second teeth of the pairs of teeth, According to a particular embodiment, each jaw comprises at least as many recesses as there are pairs of teeth, each recess being configured to be able to receive a tooth, each jaw further comprising locking means configured to lock each tooth in the recess in which it is received, and the two jaws being configured to be secured to each other so as to bring the teeth and the yoke into contact. It may, however, have a number of recesses different from the number of pairs of teeth, without departing from the scope of the present invention.

The use of jaws configured to receive the teeth allows in particular for a modular design of the stator assemblies. It will be understood that such securing means serve for example for an easy dismantling of the stator assemblies if the jaws are secured by a removable means, for example by screwing. However, it should be understood that the jaws can be secured by other technical solutions, such as, for example, by bonding, welding, shrink-fitting, or by means of a strap element for example made of metal.

According to one embodiment, the locking means comprise at least one wedge configured to be arranged in a recess and to be able to be displaced in said recess, along the tooth received in said recess, in order to lock said tooth in said recess.

The use of wedges for the locking means makes it possible to easily and accurately lock the teeth in the recesses of the jaws, without any deformation of the teeth. The magnetic performance of the machine is thereby optimized, and the teeth can also be easily removed.

It should be understood that, in a variant, the locking means may also comprise springs applying a pressure on the teeth, or else that the teeth may be bonded or welded in the recesses.

In a variant, the joined jaws exerting a pressure may enable the teeth to be brought into contact with the yoke without the need for locking wedges. The pressing force of the jaws alone would be sufficient to lock any unwanted movement of the teeth relative to the yoke, resulting in a number of recesses different from the number of pairs of teeth, as indicated hereinabove.

According to one embodiment, the dimensions of at least one of the recesses receiving a tooth are chosen to allow adjustment of the position of the tooth received in said at least one recess along the yoke of said at least one stator assembly, in the direction of displacement, by inserting a wedge in said at least one recess, for example to reduce the expansion forces of the machine.

The use, for recesses, of dimensions, in the direction of movement, greater than the dimensions needed for receiving and locking the teeth in the recesses, makes it possible, when assembling the stator assemblies, to insert one or a plurality of wedges into the recesses in order to precisely adjust the position of certain teeth along the yoke. This may be advantageous for taking up manufacturing clearances or for adding in a slight offset or a magnetic dissymmetry for reducing the expansion forces of the machine.

According to one embodiment, at least one of the recesses receiving a tooth is extended by at least one through hole configured to receive a screw able to apply a pressure on the tooth received in said recess, so as to improve a contact between said tooth and said yoke.

The use of screws configured to apply a pressure on the teeth towards the yoke serves to improve the contact and to reduce potential parasitic air gaps between the teeth and the yoke. Screws can be used to apply a pressure on the teeth towards the lateral contact faces of the yoke, or else, when the head ends of the teeth have an appropriate shape, for example a “T” shape, towards an upper surface of the yoke.

According to one embodiment, for at least one stator assembly, the fixing means comprise at least one platform, each platform being fixed both to the frame and the at least one stator assembly.

The use of platforms allows the stator assemblies to be accurately positioned relative to the frame, while making possible an easy disassembly of the stator assemblies from the frame. Preferably, the platforms are configured to be arranged between the stator assemblies and the secondary assembly, such that the stator assemblies are “supported” by the platforms. However, in a variant, the platforms may be configured so that the stator assemblies are arranged between the platforms and the secondary assembly, such that the stator assemblies are “suspended” from the platforms.

According to one embodiment, the at least one stator assembly further comprises at least one of air gap adjustment screws configured to allow a change in a spacing between the at least one platform and the at least one jaw, and air gap wedges arranged between the at least one platform and the at least one jaw, so as to allow adjustment of the air gap between the teeth of the at least one stator assembly and the opposing interaction sub-parts, by at least one of changing the number of air gap wedges and changing the thickness of the air gap wedges.

It should be understood that the air gap adjustment screws and the air gap wedges make it possible to precisely vary a spacing between the stator assemblies and the platforms, and thus to vary the air gap between the teeth of the stator assemblies and the interaction part. It is thereby possible to precisely adjust the air gap between each stator assembly and the interaction part, for example to take up manufacturing clearances. Such an adjustment makes it possible for example to have equal air gaps for all the stator assemblies and thereby to eliminate parasitic forces which are applied to the translational guide means, which are generated when the air gaps are not homogeneous.

According to one embodiment, the interaction part of the secondary assembly comprises a plurality of sheets which are stacked in the direction of displacement and are joined together, and supports which extend in the direction of displacement, at least some sheets comprising protuberances, and the supports being configured to engage the protuberances in order to ensure the mechanical strength of the secondary assembly.

The above embodiment proposes a functional configuration for the secondary assembly that allows sheets to be used. The use of sheets stacked along the direction of displacement to produce the interaction part improves the circulation of magnetic fluxes, in the interaction part, towards the teeth of the stator assemblies, and hence improves the magnetic performance of the machine.

According to one embodiment, at least one cavity, extending in the direction of displacement, is formed in the central part of the interaction part of the secondary assembly, so as to limit a magnetic short circuit in the interaction part.

The arrangement of one or more cavities in the center of the interaction part makes it possible to limit magnetic short circuits within the interaction part and thus to improve the magnetic performance of the machine.

According to one embodiment, the interaction sub-parts comprise projections made of a material able to be attracted by a magnetic field, projecting towards opposing teeth of the primary assembly.

The use of interaction sub-parts comprising projections allows controlled magnetic interactions between the interaction part and the teeth of the stator assemblies, especially when the interaction part does not include magnets, which makes it possible for example to economize on rare earths. The projections can also be used to guide magnetic fluxes into the air gap.

According to one embodiment, magnets are arranged between interaction sub-parts of the interaction part of the secondary assembly, and the interaction sub-parts are pole masses, made of magnetisable material, magnetised by magnets arranged between each pole mass.

The arrangement of magnets in the interaction part, between the interaction sub-parts, magnetises the interaction sub-parts in order to form north and south pole masses distributed alternately in the interaction part, for example to improve the magnetic interactions between the interaction part and the stator assemblies and hence the performance of the machine. It should be understood that the interaction sub-parts may also comprise projections.

According to one embodiment, at least one stator assembly further comprises an additional tooth arranged in contact with a lateral contact face of the yoke of said at least one stator assembly, said at least one stator assembly being configured such that said additional tooth makes it possible to break a magnetic symmetry of said at least one stator assembly, for example to reduce the expansion forces of the machine.

The use of an additional tooth, for at least one of the stator assemblies, breaks the magnetic symmetry and eliminates the “preferred” positions of the secondary assembly when the coils are not powered, so that the expansion forces of the machine are reduced.

According to one embodiment, at least one stator assembly is fixed to the frame by means of fixing means so as to be able to be moved, during an adjustment phase of the machine, by sliding in the direction of displacement in order to allow its position to be adjusted, for example to reduce expansion forces of the machine.

An adjustment by displacement of a stator assembly by sliding in the direction of displacement makes it possible, for example, to take up manufacturing clearances, or to add in a small magnetic dissymmetry so as to reduce the expansion forces of the machine.

According to one embodiment, at least one tooth comprises a plurality of flat sheets, stacked in a stacking direction parallel to the direction of displacement.

The use of stacked sheets to produce the teeth improves the circulation of magnetic fluxes in the teeth, in directions perpendicular to the direction of stacking of the sheets, i.e. towards the yoke or towards the interaction part, and reduces iron losses. Moreover, the use of a single sheet profile for all the teeth reduces the manufacturing costs of the machine.

According to one embodiment, at least one yoke comprises a plurality of sheets stacked in a stacking direction perpendicular to a first axis, parallel to the direction of displacement and passing through the center of the interaction part of the secondary assembly, and to a second axis, which corresponds to the axis parallel to the direction of displacement and passing through the center of said at least one yoke.

For yokes, the use of sheets stacked in a direction perpendicular to a direction going, for each pair of teeth, from the first tooth to the second tooth improves the circulation of magnetic fluxes in the yoke and reduces iron losses. Moreover, the use of a single sheet profile for all the yokes reduces the manufacturing costs of the machine.

In one embodiment, at least one of a tooth and a yoke is in the form of a part formed from magnetic powder.

The use of parts made from magnetic powder allows greater freedom for the shapes of the teeth and yokes, for example to form a widening at the base end of the teeth or for the shape of the head end of the teeth, however the circulation of magnetic fluxes in the teeth and yokes is then less optimal, for example because of iron losses, compared with the use of sheets stacked in directions perpendicular to directions of circulation of magnetic fluxes.

According to one embodiment, the translational guide means comprise at least one ball-bearing glide arranged between the primary assembly and the secondary assembly, a ball-bearing glide arranged between the frame and the secondary assembly, and a translational shaft guide element, for example a linear plain bearing or a linear ball bearing, arranged between a shaft and the frame.

Preferably, the machine comprises ball-bearing glides arranged between each stator assembly and the secondary assembly, and translational guide elements arranged between each shaft and the frame. It should be understood that the translational guide elements, for example linear plain bearings or linear ball bearings, allow the shafts to be guided in translation. However, when the secondary assembly has a great length, a deflection of the secondary assembly, for example of the shafts, may occur between the translational guide elements. It should be therefore understood that the ball-bearing glides allow the secondary assembly to be guided, and also allow the secondary assembly to be held, which makes it possible to prevent a deflection regardless of the length of the secondary assembly. It should be understood that, in a variant, the translational guide means may comprise other technical translational guide solutions known to a person skilled in the art, for example ball-bearing glides arranged between the interaction part and a part of the frame, for example a casing. It should also be understood that the machine may comprise only ball-bearing glides or only translational guide elements.

According to one embodiment, the linear movement electrical machine further comprises a casing configured to contain, at any instant of use, at least the primary assembly and the interaction part of the secondary assembly.

It should be understood that a casing protects the machine from external elements, such as dust or fluid flows, and also protects users.

According to one embodiment, the offsets between the teeth, in the direction of displacement, comply with the following conditions for a polyphase supply consisting of m phases, the successive phases of which are denoted Aᵢ with i being an integer between 1 and m, for each pair of teeth, the coils being supplied from one of the phases Aᵢ and one of the first tooth and the second tooth being denoted Aᵢ+ and the other of the first tooth and the second tooth being denoted Aᵢ−; Aᵢ− having, with respect to Aᵢ+, one of an opposite direction of winding of its coil, an opposite direction of current flow in its coil, and supply of its coil with an opposite current; the pole pitch being noted p: for each given pair h, composed of a tooth Aᵢ+ and a tooth A_{i+z}+, of another pair of teeth, there is a relative integer kₕ, and the tooth Aᵢ+ is offset by kₕ×p+(z/m)×p in the direction of displacement with respect to the tooth A_{i+z}+, with m being an integer greater than or equal to 2, and for i an integer between 1 and m-1 and z an integer between 1 and m-i; and for each given pair of teeth comprising a tooth Aᵢ+ and a tooth Aᵢ−, an offset between Aᵢ+ and Aᵢ− in the direction of displacement is equal to εₚ×(p/2), with εₚ being equal to 1 or −1 according to the given pair.

The periodicity rules proposed hereinabove allow a distribution of the teeth along the yokes which allows to obtain compact stator assemblies and an electrical machine with a small pole pitch. However, it should be understood that other distributions of the teeth along the yokes are possible for obtaining functional stator assemblies.

A linear movement electrical machine according to the present invention will now be described as a non-limiting example, with reference to the enclosed drawings.

On the drawings:

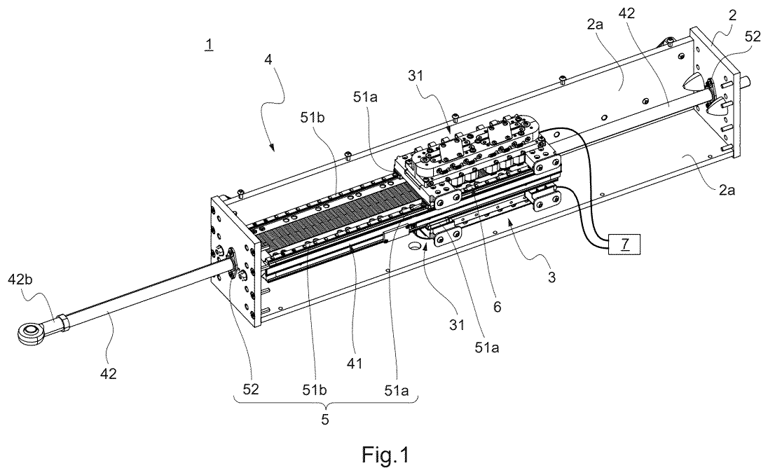

FIG. 1 is a perspective view of a linear movement electrical machine according to an embodiment of the present invention, the electrical module is shown schematically and two sides of the casing are not shown in order to allow the elements located inside to be seen.

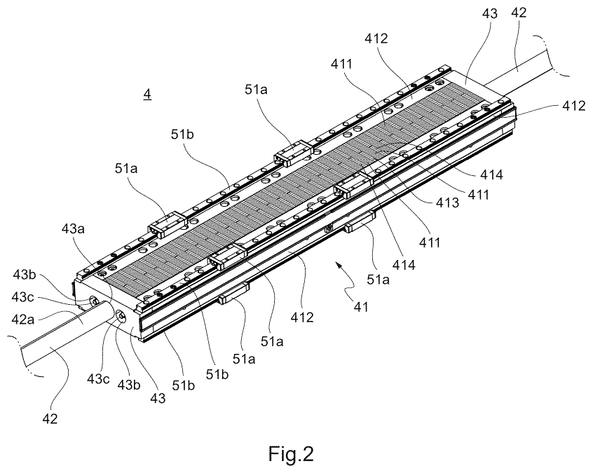

FIG. 2 is a perspective view of the secondary assembly of FIG. 1.

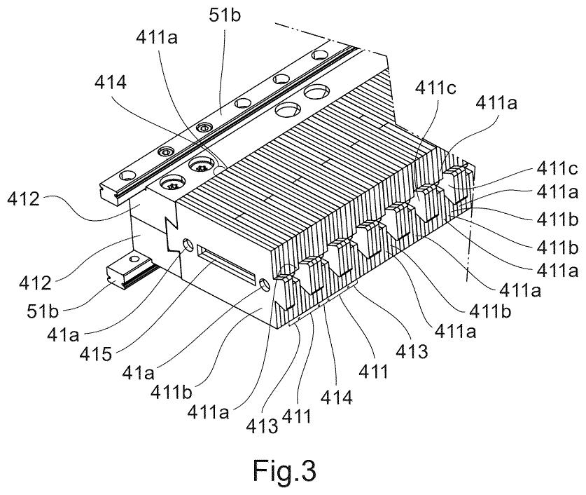

FIG. 3 is an enlarged perspective view of one end of the secondary assembly of FIG. 1, the shaft fixing element of that end and the supports on one side not being shown in order to make the view clearer.

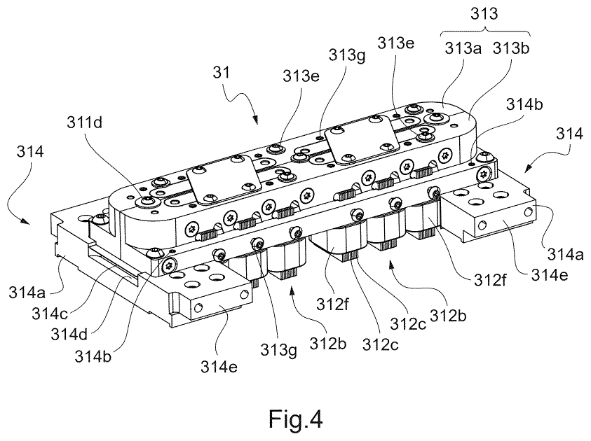

FIG. 4 is a perspective view of a stator assembly shown in FIG. 1.

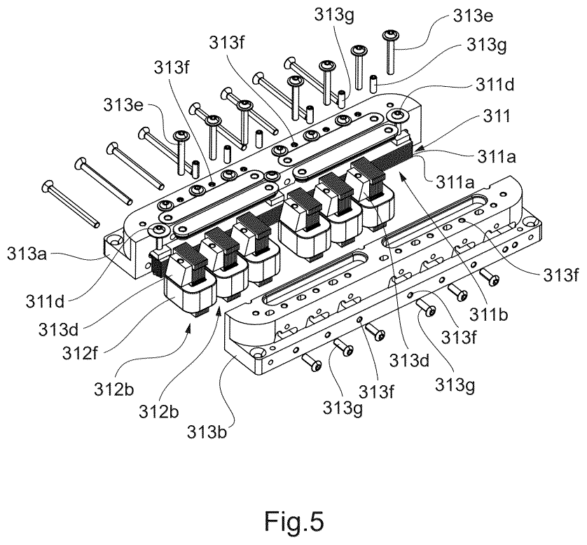

FIG. 5 is an exploded perspective view of a stator assembly shown in FIG. 1, only the first teeth of the pairs of teeth are visible and the fixing means are not shown.

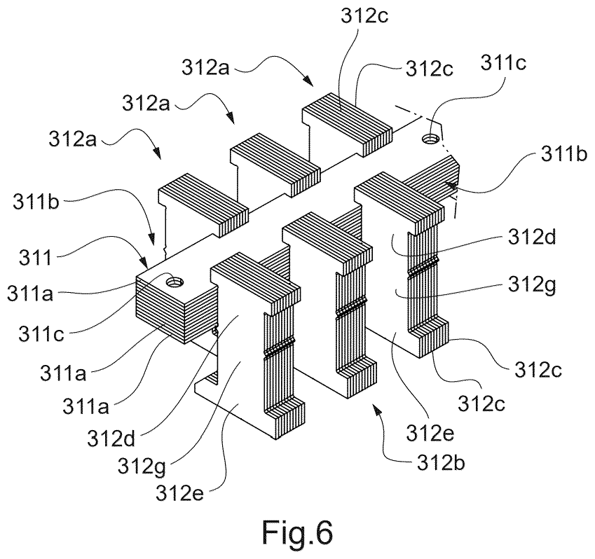

FIG. 6 is an enlarged perspective view of one end of the yoke and of certain teeth of a stator assembly shown in FIG. 1.

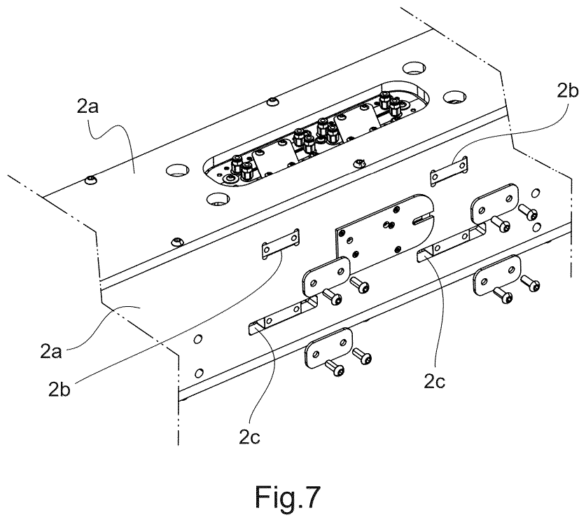

FIG. 7 is an enlarged perspective view of the machine shown in FIG. 1, the two sides of the casing not shown in FIG. 1 being shown herein.

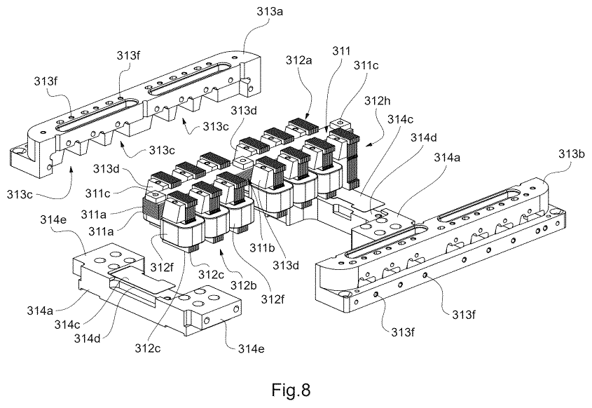

FIG. 8 is an exploded perspective view of a stator assembly according to a variant of the embodiment shown in FIG. 1, this stator assembly comprising an additional tooth.

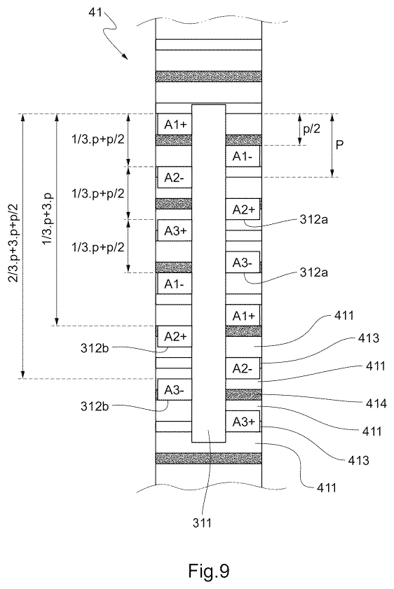

FIG. 9 is a top view of the interaction part of the secondary assembly, and of the yoke and teeth of a stator assembly of FIG. 1 illustrating the distribution of teeth along the yoke and the spacing between teeth depending on the structure of the interaction part, the coils are not shown in order to make the view clearer.

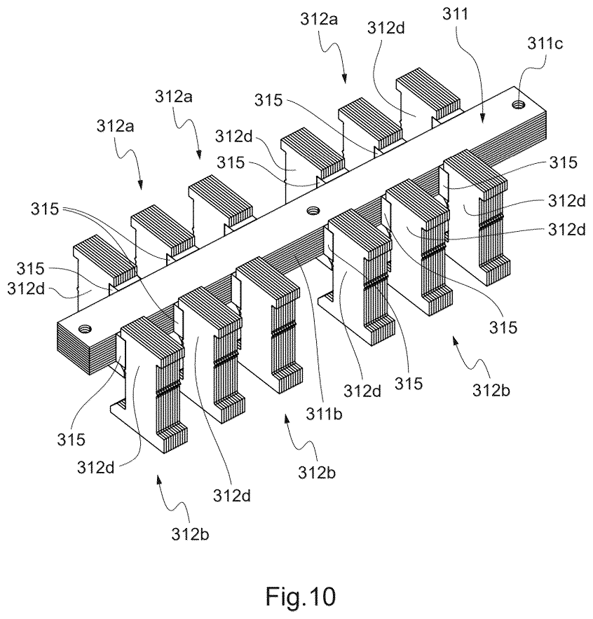

FIG. 10 is a perspective view of the yoke and of the teeth of a stator assembly according to a variant of the embodiment of FIG. 1.

Referring first of all to FIG. 1, it can be seen that a linear movement electrical machine 1 according to an embodiment of the present invention has been shown therein. The machine 1 comprises a primary assembly 3 configured to be fixed to a frame 2, a secondary assembly 4 extending in a so-called direction of displacement, and translation guide means 5 configured to guide a relative translation movement of the secondary assembly 4 with respect to the primary assembly 3 in the direction of displacement.

The machine 1 illustrated in FIG. 1 is configured to operate in motor mode, in which electrical energy is converted into mechanical energy of the relative linear movement type of the secondary assembly 4 with respect to the primary assembly 3 in the direction of displacement, and in generator mode, in which mechanical energy of the relative linear movement type of the secondary assembly 4 with respect to the primary assembly 3 in the direction of displacement is converted into electrical energy. However, it should be understood that, in a variant, the machine 1 can be configured to operate only in motor mode or only in generator mode.

It should also be understood that, during a relative linear movement of the secondary assembly 4 with respect to the primary assembly 3, the primary assembly 3 may be fixed and the secondary assembly 4 may be movable, or the primary assembly 3 may be movable and the secondary assembly 4 may be fixed, or the primary assembly 3 and the secondary assembly 4 may both be movable with a relative movement of the secondary assembly 4 with respect to the primary assembly 3.

According to the embodiment shown in FIG. 1, the primary assembly 3 comprises two stator assemblies 31. The two stator assemblies 31 are arranged in opposite directions, and each stator assembly 31 is configured to be fixed to the frame 2. It should thus be understood that the primary assembly 3 is movable when the frame 2 is movable, and that the primary assembly 3 is fixed when the frame 2 is fixed. It should also be understood that the number of stator assemblies 31 may be different, as will be mentioned later.

According to the embodiment shown in FIG. 1, the secondary assembly 4 comprises an interaction part 41 and two shafts 42. Each shaft 42 is integral with the interaction part 41 and extends in the direction of displacement. According to the embodiment shown in FIG. 1, each shaft 42 is fixed to one end, in the direction of displacement, of the interaction part 41 by means of a shaft fixing element 43. Each shaft fixing element 43 has a generally parallelepipedal shape and comprises a central through hole 43a formed along the direction of displacement. The central through hole 43a comprises a first part having a diameter substantially equal to a diameter of a first end 42a of a shaft 42, and a second part having a diameter smaller than the diameter of the first part, such that the first end 42a of the shaft 42 can be received in the first part of the through hole 43a and a screw configured to engage the first end 42a can be received in the second part of the through hole 43a, so as to fix the first end 42a of the shaft 42 to the shaft fixing element 43. It should be understood that, in a variant, the first end 42a of the shaft 42 can be fixed to the shaft fixing element 43 in another way, for example by other screwing configurations, by welding, by shrink-fitting or by bonding.

Each fixing element 43 further includes two lateral through holes 43b formed in correspondence with two lateral through holes 41a formed in the interaction part 41, and in correspondence with lateral through holes 43b of the other shaft fixing element 43, so that two through pins 43c can be introduced respectively into a lateral through hole 43b of a shaft fixing element 43, into a lateral through hole 41a of the interaction part 41, and into a lateral through hole 43b of the other shaft fixing element 43, to fix the shaft fixing elements 43 to the interaction part 41. It should be understood that, in a variant, the shaft fixing elements 43 can be fixed to the interaction part 41 in another way, for example by other screwing configurations, by welding, by shrink-fitting or by bonding. It should also be understood that the shafts 42 can be fixed directly to the interaction part 41, for example by welding or bonding. According to the embodiment shown in FIG. 1, each shaft 42 is configured to be connected, at a second end 42b, to an element external to the machine 1, for example a fixed anchor or an external element to be moved. It should also be understood that, in a variant, the machine 1 may comprise only one shaft 42.

As shown in FIG. 1, the frame 2 preferably comprises metal sheets which form a casing 2a configured to contain, at any moment of use, the primary assembly 3 and the interaction part 41 of the secondary assembly 4. However, it should be understood that the frame could be a simple structure, made of tubes or bars, adapted to position the primary assembly 3 with respect to the secondary assembly 4.

According to the embodiment shown in FIG. 1, the interaction part 41 is generally parallelepipedal and the cross-section of the interaction part 41 along a plan perpendicular to the direction of displacement, is rectangular. The interaction part 41 is configured to be arranged between the two opposite stator assemblies 31, such that two sides of the rectangle of the cross section are oriented toward the stator assemblies 31 of the primary assembly 3, preferably the two large sides of the rectangle in order to maximize the interaction zones.

A plurality of interaction sub-parts 411 are distributed along the direction of movement within the interaction part 41.

The interaction sub-parts 411 are distributed within the interaction part 41 in such a way that, in use, each stator assembly 31 of the primary assembly 3 is arranged facing interaction sub-parts 411 of the interaction part 41, so as to allow magnetic interactions between the interaction sub-parts 411 and the stator assemblies 31.

It should be understood that the expression “facing” also covers variants for which, in extreme end-of-travel positions of a relative movement of the secondary assembly 4 with respect to the primary assembly 3, a part of at least one of the stator assemblies 31 is no longer directly facing the interaction part 41, i.e. an extreme position in which a part of the at least one stator assembly 31 is not adapted to magnetically interact with the interaction part 41.

It should also be understood that, in a variant of the embodiment shown in FIG. 1, the primary assembly 3 may comprise a single stator assembly 31 or a number of stator assemblies 31 greater than two. It should also be understood that the shape of the interaction part 41 of the secondary assembly 4 depends directly on the number of stator assemblies 31 and on the arrangement thereof, so as to have interaction sub-parts 411 facing each stator assembly 31.

It will be understood that, according to variants, the cross-section of the interaction part 41 may be any regular polygon, for example a hexagon, and the primary assembly 3 may comprise as many stator assemblies 31 as the regular polygon has sides, for example six, the machine 1 being configured such that each stator assembly 31 is arranged opposite one side of the regular polygon corresponding to the cross-section of the interaction part 41.

Furthermore, the configuration of the stator assemblies 31 and of the interaction part 41 could, in a variant, still be different.

According to a variant, the primary assembly 3 could comprise from one to four stator assemblies 31, the cross-section of the interaction part 41 could be square, and the interaction part 41 could be configured so that a corner of the square is oriented toward each stator assembly 31.

It should also be understood that, preferably, the shape of the stator assemblies 31 adapted to correspond to the configuration of the interaction part 41. The stator assemblies 31 could for example have an angle shape and a V-shaped cross-section, so that the opening of the V-shape is oriented toward a corner of the square of the cross-section of the interaction part 41.

According to another variant, the cross-section of the interaction part 41 could be an hourglass, and the interaction part 41 oriented in such a way that a V-shape side of the hourglass is oriented toward each stator assembly 31, and the cross-section of the stator assemblies 31 could have the shape of a triangle which corresponds to the V-shape side of the hourglass.

According to yet another variant, the cross-section of the interaction part 41 could comprise other concave shapes and the cross-section of the stator assemblies 31 could comprise other corresponding convex shapes, or vice versa. The interaction part 41 could be for example cylindrical. Finally, a person skilled in the art would understand that combinations of the variants mentioned hereinabove are possible.

According to the embodiment shown in FIGS. 1 to 3, the translational guide means 5 comprise ball-bearing glides 51a, rails 51b and shaft translational guide elements 52, the machine 1 comprising four ball-bearing glides 51a and two rails 51b for each stator assembly 31, and one shaft translational guide element 52 for each shaft 42. It should be understood that a shaft translational guide element can be a linear plain bearing (also known as a plain ring bushing, or sliding bearing) or a linear ball bearing (also known as a ball bushing) or any other guide element.

Each rail 51b is arranged, laterally and in the direction of displacement, on a face of the interaction part 41 oriented toward a stator assembly 31 and each ball-bearing glide 51a is fixed to a stator assembly 31 so as to be arranged between said stator assembly 31 and the interaction part 41. The ball-bearing glides 51a and the rails 51b are preferably fixed by screwing but could also be fixed by other fixing techniques, for example by bonding or by welding.

Each ball-bearing glide 51a cooperates with a rail 51b so as to allow relative movement of the secondary assembly 4 with respect to the primary assembly 3 in translation in the direction of displacement and so as to lock any other movement. The use of ball-bearing glides 51a and rails 51b arranged between the stator assemblies 31 and the interaction part 41 has the particular advantage of enabling the interaction part 41 to be supported, which makes it possible to prevent a deflection of the secondary assembly 4, for example when the secondary assembly 4 has a great length, and therefore allows a longer secondary assembly 4 to be used.

Each translational shaft guide element 52 is fixed to the frame 2 and engages with a shaft 42 so as to guide a relative translational movement of said shaft 42 with respect to the frame 2, the guide also makes it possible to support the interaction part 41 on the shafts 42.

It should be understood that, in a variant, the machine 1 may comprise only ball-bearing glides 51a and rails 51b, or only shaft translational guide elements 52. It should also be understood that a relative movement of the secondary assembly 4 with respect to the primary assembly 3 could be guided by other guide means, for example sliding connections fixed laterally between the interaction part 41 and the frame 2.

With reference to FIGS. 2 and 3, the structure of the interaction part 41 of the secondary assembly 4 will now be described in greater detail. The interaction part 41 comprises interaction sub-parts 411, supports 412, magnets 413, 414, and a cavity 415.

According to the embodiment shown in FIG. 3, the interaction sub-parts 411 comprise rectangular sheets 411a and sheets called butterfly sheets 411b, stacked in the direction of displacement and assembled together, for example by bonding or welding. The rectangular sheets 411a and the butterfly sheets 411b are made of a magnetisable material, for example alloys of magnetic stainless steel such as alloy Z30C13, alloys of the magnetic oxidizable steel type such as alloy XC10, or electrical steel for electrical machines such as iron silicon sheets. The use of metal sheet 411a, 411b to produce the interaction sub-parts 411 makes it possible to reduce the manufacturing costs and to improve the circulation of the magnetic field, in particular in a direction going from the interaction sub-parts 411 toward the facing stator assembly 31. However, it should be understood that the interaction sub-parts 411 may also, in a variant, be monolithic parts, for example made from magnetic powder.

According to the embodiment shown in FIG. 3, the interaction part 41 further comprises magnets 413, 414 polarized in the direction of displacement, i.e. that one side of the magnets 413, 414 in the direction of displacement has a polarity opposite to that of an opposite side in the direction of displacement. According to the embodiment shown in FIG. 3, the magnets 413, 414 are permanent magnets. However, it should be understood that the magnets 413, 414 could also be other types of magnets, for example electromagnets or superconducting coils, in order to be able to modulate the magnetic induction field created by the interaction part 41, or in order to substitute permanent magnets containing rare earths. The magnets 413, 414 are divided into a first set of so-called north-south magnets 413 and a second set of so-called south-north magnets 414, the polarities of the north-south magnets 413 being reversed with respect to the polarities of the south-north magnets 414.

According to the embodiment shown in FIG. 3, the interaction part 41 is formed by a successive assembly of interaction sub-parts 411, north-south magnets 413 and south-north magnets 414.

North-south magnets 413 and south-north magnets 414 are alternately interposed between the interaction sub-parts 411, such that a given interaction sub-part 411 is either in contact with south sides of the magnets 413, 414 or in contact with north sides of the magnets 413, 414.

North pole masses, i.e. interaction sub-parts 411 in contact with north sides of north-south magnets 413 and south-north magnets 414, and south pole masses, i.e. interaction sub-parts 411 in contact with south sides of north-south magnets 413 and south-north magnets 414 are formed alternately. The use of pole masses between the magnets 413, 414 makes it possible, in particular, to guide the magnetic field in order to limit magnetic field leaks between two consecutive magnets, to increase the induction of the air gap, and to reduce a demagnetization effect of the magnets 413, 414 under the effect of large currents in the stator assemblies 31.

Preferably, all the interaction sub-parts 411 have the same thickness in the direction of displacement, and all the magnets 413, 414 have the same thickness in the direction of displacement.

According to a variant (not shown), the interaction sub-parts 411 may comprise projections projecting toward the facing stator assembly 31. As will be discussed in detail later, when the interaction sub-parts 411 comprise projections, the interaction part 41 may be free of magnets 413, 414. The interaction part 41 is then formed by a succession of projecting interaction sub-parts 411 spaced apart in the direction of displacement.

According to the embodiment shown in FIG. 3, a cavity 415, extending in the direction of displacement, is also formed in the central part of the interaction part 41. The cavity 415 makes it possible in particular to avoid a magnetic short circuit in the interaction part 41 between adjacent north-south magnets 413 and south-north magnets 414, by preventing the magnetic flux from looping back inside the interaction part 41, which thus limits the magnetic field leaks. According to the embodiment shown in FIG. 3, each butterfly sheet 411b extends on either side of the cavity 415 and comprises a central through hole in the direction of displacement, and the dimensions of the rectangular sheets 411a and the magnets 413, 414 are chosen so that rectangular sheets 411a and magnets 413, 414 may also be arranged on either side of the cavity 415 so as to define the latter. It should be understood that, in a variant, the rectangular sheets 411b and the magnets 413, 414 could also extend on either side of the central cavity 415 and comprise a central through hole. Still in a variant, the interaction part 41 could also comprise a plurality of successive cavities distributed along the direction of displacement.

The butterfly sheets 411b comprise protuberances 411c which extend laterally away from the stator assemblies 31. The interaction part 41 comprises two pairs of supports 412 which extend laterally along the interaction sub-parts 411 in the direction of displacement. Each pair of supports 412 is configured to engage the protuberances 411c of the butterfly sheets 411b and sandwich the protuberances 411c. The supports 412 of each pair of supports 412 are also configured to be secured together, for example by screwing, bonding or welding, so as to hold the protuberances 411c and improve the mechanical strength of the interaction part 41. Preferably, the shaft fixing elements 43 are configured to prevent sliding of the supports 412 in the direction of displacement.

It should also be understood that the lateral through-holes 41a of the interaction part 41 are formed in the interaction sub-parts 411, so that the through-rods 43c passing through the lateral through-holes 41a also participate in the mechanical strength of the interaction sub-parts 411 and of the interaction part 41.

Referring to FIGS. 4 to 6, the structure of a stator assembly 31 of the machine shown in FIG. 1 will now be described in greater detail.

According to the embodiment shown in FIGS. 4 to 6, a stator assembly 31 comprises a yoke 311, six pairs 312 of teeth 312a, 312b, securing means 313, and fixing means 314.

The machine 1 shown in FIG. 1 is a three-phase machine. It should be understood that the machine 1 may comprise a number of pairs 312 of teeth 312a, 312b other than six, in particular as a function of the number of phases of the polyphase alternating power supply used. The number of pairs 312 of teeth 312a, 312b is preferably a multiple of the number of phases of the polyphase AC power supply. The minimum number of pairs 312 of teeth 312a, 312b is two pairs 312 to enable the machine 1 to operate in motor mode, and is one pair 312 to enable the machine 1 to operate in generator mode.

According to the embodiment shown in FIGS. 5 and 6, each yoke 311 comprises a plurality of sheets 311a assembled together and stacked in a stacking direction perpendicular to a first axis, parallel to the direction of displacement and passing through the center of the interaction part 41 of the secondary assembly 4, and to a second axis, parallel to the direction of displacement and passing through the center of the yoke 311.

It should be understood that, preferably, all the sheets 311a of the yokes 311 are identical, in particular in order to facilitate manufacture and reduce production costs.

In FIGS. 5 and 6, the sheets 311a are flat, but, however, it should be understood that in the case of other configurations of interaction part 41 and stator assemblies 31, for example same described hereinabove, the sheets 311a do not need to be flat. The sheets 311a may be for example in the form of an angle with a V-shaped cross-sectional profile.

As shown in FIGS. 5 and 6, each tooth 312a, 312b comprises a plurality of sheets 312c assembled together and stacked in a stacking direction parallel to the direction of displacement.

It will be understood that, preferably, all the sheets 312c of the teeth 312a, 312b are identical, in particular in order to facilitate manufacture and reduce production costs.

The sheets 311a of the yokes 311 and the sheets 312c of the teeth 312a, 312b are made of a magnetisable material, for example laminated sheets for electrical machines such as sheets of iron silicon or iron cobalt as known to a person skilled in the art.

For each yoke 311 and for each tooth 312a, 312b, the sheets 311a, 312c are assembled together, preferably by bonding. However, it should be understood that other technical solutions are possible for assembling the sheets 311a, 312c together, for example welding, riveting, shrink-fitting of a rod passing through the sheets 311a, 312c in the stacking direction thereof, or strapping, for example by means of a metal strap.

The machine 1 is configured to promote, for each pair 312 of teeth 312a, 312b, transverse magnetic looping between the first tooth 312a, the yoke 311 and the second tooth 312b. The use of sheets 311a, 312c for the yokes 311 and the teeth 312a, 312b makes it possible to improve the circulation of a magnetic field through the yokes 311 and the teeth 312a, 312b. Moreover, the stacking directions of the sheets 311a of the yokes 311 and of the sheets 312c of the teeth 312a, 312b are always perpendicular to the direction of circulation of a magnetic field in the yokes 311 and the teeth 312a, 312b, which makes it possible to further improve the circulation of such a magnetic field and to minimize losses by eddy currents. However, it should be understood that in a variant each yoke 311 and each tooth 312a, 312b could be formed of a single monolithic piece, for example made from magnetic powder heated and pressed to produce the yokes 311 and the teeth 312a, 312b in the desired shape, or even produced by 3D printing.

Each yoke 311 comprises two lateral contact faces 311b defined on either side of the axis parallel to the direction of displacement and passing through the center of the yoke 311.

Each tooth 312a, 312b comprises a head end 312d which is configured to come into contact with a lateral contact face 311b of a yoke 311, as shown in FIG. 6, and a base end 312e, opposite the head end 312d, which is configured to be oriented toward the interaction part 41 of the secondary assembly 4, so that an air gap 6 is formed between the teeth 312a, 312b and the interaction sub-parts 411. Each tooth 312a, 312b is configured to interact magnetically with interaction sub-parts 411 of the facing secondary assembly 4.

The machine 1 is configured in such a way that during a relative movement of the secondary assembly 4 with respect to the primary assembly 3, an interaction sub-part 411 of the secondary assembly 4 moves parallel relative to the surface formed by the base ends 312e of the teeth 312a, 312b of the facing stator assembly 31.

In the figures, the base ends 312e of the teeth 312a, 312b and the interaction sub-parts 411 are flat, so that the structure is simple. However, it should be understood that, in a variant, the base ends 312e of the teeth 312a, 312b could comprise grooves extending in the direction of displacement, and the interaction sub-parts 411 could comprise protuberances of mating shapes also extending in the direction of displacement, or vice versa. Such structure is more complex, but allows the interaction zones between the teeth 312a, 312b and the interaction sub-parts 411 to be increased.

Each stator assembly 31 is configured in such a way that the pairs 312 of teeth 312a, 312b are spaced apart from one another along the yoke 311 in the direction of displacement, and the teeth 312a, 312b of a pair 312 of teeth 312a, 312b are arranged diagonally on the yoke 311, so that for each pair 312 of teeth 312a, 312b, a first tooth 312a is in contact with a lateral contact face 311b of the yoke 311 and a second tooth 312b is in contact with another lateral contact face of the yoke 311b of the yoke 311. The machine 1 is further configured in such a way that, for each pair 312 of teeth 312a, 312b, when the first tooth 312a is directly facing an interaction sub-part 411, the second tooth 312b is directly opposite another interaction sub-part 411. When the interaction part 41 comprises magnets 413, 414, the machine 1 is further configured so that said interaction sub-part 411 directly opposite the first tooth 312a is of opposite polarity to the interaction sub-part 411 directly opposite the second tooth 312b. Such diagonal organization serves in particular to reduce the pole pitch of the machine 1 and to increase the compactness of the electrical machine 1.

Each stator assembly 31 further comprises securing means 313, which are configured to secure the teeth 312a, 312b to the yoke 311. Preferably, the securing means 313 are made of a non-magnetisable material, for example an aluminum alloy, a titanium alloy, a stainless-steel alloy, or else plastic, for example ABS (acrylonitrile butadiene styrene) or a PA (polyamide), and encapsulate the teeth 312a, 312b and the yoke 311.

According to the invention, the securing means 313 are configured so as to be adapted to secure the teeth 312a, 312b to the yoke 311 without any deformation of the teeth 312a, 312b or of the yoke 311 altering the circulation of a magnetic field or increasing iron losses.

According to the embodiment shown in FIGS. 4 and 5, the securing means 313 comprise two jaws 313a, 313b which are arranged on either side of the yoke 311, and which are configured to secure the teeth 312a, 312b to the yoke.

According to the embodiment shown in FIGS. 4 and 5, each jaw 313a, 313b comprises a single plate. However, a person skilled in the art would understand that each jaw 313a, 313b may, in a variant, comprise a plurality of plates secured to each other to form said jaw 313a, 313b.

For each stator assembly 31, a first jaw 313a is intended to receive the first teeth 312a of the pairs 312 of teeth 312a, 312b, and a second jaw 313b is intended to receive the second teeth 312b of the pairs 312 of teeth 312a, 312b.

In the non-limiting embodiment shown, each jaw 313a, 313b comprises as many recesses 313c as there are pairs 312 of teeth 312a, 312b, and each recess 313c is configured to be adapted to receive a tooth 312a, 312b. According to a variant detailed below, one of the jaws 313a, 313b may comprise an additional recess 313c. Alternatively, the assembled jaws exerting pressure may enable the teeth to be brought into contact with the yoke without using locking wedges. The pressing force of the jaws alone would be sufficient to lock any unwanted movement of the teeth relative to the yoke. In such case, the number of recesses is different from the number of pairs of teeth.

Each jaw 313a, 313b further comprises locking means configured to lock each tooth 312a, 312b in the recess 313c in which same is received. According to the invention, the locking means are configured so as to be adapted to lock the teeth 312a, 312b in the recesses 313c without deformation of the teeth 312a, 312b altering the circulation of a magnetic field or increasing iron losses.

According to the embodiment shown in FIG. 5, the means for locking a jaw 313a, 313b comprise, for each recess 313c, a wedge 313d, and a screw 313e configured to pass through the jaw 313a, 313b and to make possible a displacement of the wedge 313d. Preferably, the wedges 313d are made of a non-magnetisable material, for example an aluminum alloy, a titanium alloy, a stainless steel alloy, or plastic.

Each recess 313c comprises an inclined wall, and each wedge 313d is configured to be arranged in a recess 313c in contact with the inclined wall, so as to be adapted to be displaced in the recess 313c by the associated screw 313e, along the inclined wall and along the tooth 312a, 312b received in the recess, in order to lock said tooth in the recess 313c. The locking means make it possible in particular to lock the teeth 312a, 312b in the recesses 313c without any deformation and without any damage.

Moreover, the securing means 313 can be further configured to make possible a reduction in the forces for releasing the machine 1, or to take up manufacturing clearances, by making possible an adjustment of the position of the teeth 312a, 312b along the yokes 311.

In such case, the dimensions of each recess 313c receiving a tooth 312a, 312b are chosen to make possible an adjustment of the position of the tooth 312a, 312b received in the recess 313c along the yoke 311, in the direction of displacement. The locking means then further comprise wedges, and each wedge is configured to be inserted into a recess 313c, opposite both the inclined wall and the wedge 313d. Thereby, when the wedge 313d is displaced by the screw 313e, the wedge 313d presses and locks the tooth 312a, 312b against the wedge. Therefore, it should be understood that it is possible to modify the position of the tooth 312a, 312b along the yoke 311 by choosing the thickness of the wedge.

It should be understood that the locking means comprising wedges 313d lead to an easy dismantling, for example to replace a defective component, to modify the coils 312f or to recycle the components at the end of the life of the machine 1. However, in a variant, the locking means may take other forms. For example, the locking means may comprise a resin configured to lock the teeth 312a, 312b in the recesses 313c, or springs configured to apply pressure to the teeth 312a, 312b and make possible a locking in the recesses 313c. Resin refers in particular to a natural, artificial or synthetic polymer product. In a variant, the teeth 312a, 312b may also be bonded or welded.

Moreover, for each stator assembly 31, the two jaws 313a, 313b are configured to be secured to each other so as to bring the teeth 312a, 312b into contact with the yoke 311. Preferably, the jaws 313a, 313b are secured by screwing. However, it should be understood that other technical solutions can be used, for example bonding, welding or strapping using a strap, for example made of metal.

According to the embodiment shown in FIGS. 4 and 5, each recess 313c of the jaws 313a, 313b is extended by two through holes 313f. A first through hole 313f extends along the stacking direction of the sheets 311a of the yoke 311, and a second through hole 313f extends along a direction perpendicular to the stacking direction of the sheets 311a of the yoke 311 and perpendicular to the direction of displacement. The holes 313f are configured to receive screws 313g configured to apply pressure to the teeth 312a, 312b toward the yoke 311, so as to improve contact between the teeth 312a, 312b and the yoke 311 and to limit parasitic air gaps between the teeth 312a, 312b and the yoke 311, which makes it possible to improve the general performance of the machine 1.

It should be understood that the screws 313g configured to apply pressure to the teeth 312a, 312b in the direction perpendicular to the stacking direction of the sheets 311a of the yoke 311 and perpendicular to the direction of displacement make it possible to improve the contact between the teeth 312a, 312b and the lateral contact faces 311b of the yokes 311.

It should also be understood that the screws 313g configured to apply pressure to the teeth 312a, 312b in the stacking direction of the sheets 311a of the yoke 311 find the utility thereof when the shape of the head end 312d of the teeth 312a, 312b allows the teeth 312a, 312b and the yoke 311 to be brought into contact in the stacking direction of the sheets 311a of the yoke 311, for example when the head ends 312d of the teeth 312a, 312b are T-shaped, as shown in FIGS. 5 and 6.

The use of teeth 312a, 312b with T-shaped head ends 312d makes it possible in particular to lock a displacement of the teeth 312a, 312b in the stacking direction of the sheets 311a of the yoke 311, for example a displacement linked to the magnetic interactions between the teeth 312a, 312b and the interaction part 41.

It should also be understood that, in a variant, the recesses 313c may comprise a through hole 313f in another direction, so as to improve contact between the teeth 312a, 312b and the yoke 311.

It should also be understood that, in a variant, the screws 313g configured to apply pressure to the teeth 312a, 312b toward the yoke 311 can be replaced by other means of applying force, for example springs received in the recesses 313c.

Preferably, each yoke 311 is also secured to the jaws 313a, 313b. For example, holes 311c may be formed in the yoke 311 in the stacking direction of the sheets 311a, and screws 311d may be configured to pass through the jaws 313a, 313 and to engage with the holes 311c, so as to secure the yoke 311 to the jaws 313a, 313b. It should be understood that the holes 311c may directly comprise a thread or that a nut may be fixed in correspondence with the holes 311c to make possible an engagement with the screws 311d.

It should be understood that the securing means 313 comprising jaws 313a, 313b allow easy dismantling, for example to replace a defective component, to modify the coils 312f or to recycle the components at the end of the life of the machine 1. However, in a variant of the embodiment shown in FIGS. 4 and 5, the securing means 313 could also take other forms, and for example comprise a resin configured to encapsulate the teeth 312a, 312b on the yoke 311. Resin refers in particular to a natural, artificial or synthetic polymer product. In a variant, the teeth 312a, 312b may also be bonded or welded to the yoke 311. In a variant or in addition, the yoke 311 may comprise a groove, extending for example in the direction of displacement, and the teeth 312a, 312b may comprise projections configured to engage in the groove, or vice versa.

Preferably, for all the stator assemblies 31, all the teeth 312a, 312b have the same thickness along the direction of displacement, all the first teeth 312a in contact with a lateral contact face 311b are spaced by the same distance along the direction of displacement, and all the second teeth 312b in contact with another lateral contact face 311b are spaced by the same distance along the direction of displacement.

As illustrated in FIGS. 4 and 5, each tooth 312a, 312b of the pairs 312 of teeth 312a, 312b is surrounded by a coil 312f around a body section 312g. Each coil 312f may for example comprise a copper, aluminum or superconducting material wire.

The machine 1 further comprises an electrical module 7, for example an inverter in motor mode or a rectifier bridge in generator mode, connected to the coils 312f.

The electrical module 7 is configured to enable the coils 312f to be supplied with power in motor mode and to collect alternating currents coming from the coils 312f in generator mode. Preferably, the power supply is a three-phase AC power supply, but however, it should be understood that a different number of phases can be used for variants of the embodiment shown in the figures. More preferably, the supply voltages have a sinusoidal profile. However, it should be understood that the profiles of the voltages may, in a variant, be for example rectangular or trapezoidal.

As indicated hereinabove, the number of pairs 312 of teeth 312a, 312b is preferably chosen as a function of the number of phases and each pair 312 of teeth 312a, 312b is supplied from one of the phases of the polyphase alternating power supply.

Each coil 312f of a pair 312 of teeth 312a, 312b is configured such that when powered in motor mode, the coil generates a magnetic polarity at the base end 312e of the tooth 312a, 312b which same surrounds and generates a magnetic polarity opposite to the head end 312d of the tooth 312a, 312b which same surrounds, and the coils 312f of each pair 312 of the teeth 312a, 312b are configured to generate a polarity at the base end 312e, and at the head end 312d respectively, of the first tooth 312a and to generate an opposite polarity at the base end 312e, and at the head end 312d respectively, of the second tooth 312b, so as to create a transverse magnetic loop between said first tooth 312a, the yoke 311 and said second tooth 312b. It should be understood that the opposite polarity can be obtained either with an opposite winding direction or with a supply with an opposite current.

Since the power supply to the coils 312f in motor mode is alternating and polyphase, the polarities and intensities of the magnetic fields generated by the coils 312f vary over time according to the variations of the polyphase alternating power supply.

In generator mode, magnetic interactions between the interaction sub-parts 411 of the interaction part 41 of the secondary assembly 4 and the base ends 312e of the teeth 312a, 312b, during a relative movement of the secondary assembly 4 with respect to the primary assembly 3, lead to the generation of alternating currents in the coils 312f which surround the teeth 312a, 312b.

Still in generator mode, since the coils 312f are not powered, the magnetic interactions between the teeth 312a, 312b and the interaction sub-parts 411 are possible by means of magnets 413, 414 arranged in the interaction part 41 or magnets 315 arranged in the stator assemblies 31 between the teeth 312a, 312b and the yoke 311. It will also be understood that the machine 1 may comprise both magnets 413, 414 arranged in the interaction part 41, and magnets 315 arranged in the stator assemblies 31.

FIG. 10 shows an example of the arrangement of magnets 315 between the head ends 312d of the teeth 312a, 312b and the lateral contact faces 311b of the yoke 311 of a stator assembly 31. It should be understood that in such case, the dimensioning of the securing means 313 is adjusted to enable the teeth 312a, 312b and the magnets 315 to be secured to the yoke 311.

As mentioned hereinabove, according to a variant, when the interaction sub-parts 411 comprise projections, the interaction part 41 may be free of magnets 413, 414, so that the interaction part 41 is formed by a succession of projecting interaction sub-parts 411 spaced apart in the direction of displacement. In such case, in order to enable the machine 1 to operate in generator mode, magnets 315 are arranged between the head ends 312d of the teeth 312a, 312b and the lateral contact faces 311b of the yokes 311, as shown for example in FIG. 10, so as to permit magnetic interactions between the interaction sub-parts 411 and the teeth 312a, 312b when the coils 312f are not powered and to allow the machine 1 to operate in generator mode.

It should be specified that an arrangement of magnets 315 in the stator assemblies 31 does not prevent the machine 1 from operating in motor mode.

The magnets 315 arranged in the stator assemblies 31 may for example be permanent magnets, electromagnets or superconducting coils.

Preferably, the machine 1 is configured to maximize the magnetic interaction zones between the primary assembly 3 and the secondary assembly 4. More particularly, each tooth 312a, 312b is preferably configured so that a projected area of the base end 312e on the interaction part 41 is greater than a projected area of the body section 312g on the interaction part 41. According to the embodiment shown in FIG. 6, the sheets 312c of each tooth 312a, 312b are configured in such a way that the base end 312e of the tooth 312a, 312b has a widening in the direction perpendicular to the stacking direction of the sheets 311a of the yoke 311 and perpendicular to the direction of displacement, so as to increase the surface area through which the magnetic flux passing through the tooth 312a, 312b and the facing interaction sub-parts 411. It should be understood that, in the case of teeth 312a, 312b in monolithic form, for example based on magnetic powder as mentioned hereinabove, the widening may also extend in the direction of displacement. A widening in the direction of displacement makes it possible for example to further increase the surface area through which the magnetic flux passing through the tooth 312a, 312b and the interaction sub-parts 411 passes, or else to have an even smaller body section 312g with respect to the base end 312e, so as to increase the volume available around the tooth 312a, 312b to receive the coil 312f surrounding the tooth, without reducing the exchange zone with the interaction sub-parts 411.

It should be understood that, when a projected surface area of the base end 312e onto the interaction part 41 is greater than a projected surface area of the body section 312g onto the interaction part 41, the winding of a coil 312f around the body sections 312g of the teeth 312a, 312b is much more complex.

It can be specified herein that the securing means 313 according to the invention serve to form the coils 312f around the teeth 312a, 312b easily when the teeth 312a, 312b are independent of the yokes 311, i.e. before assembly, and then to secure the teeth 312a, 312b surrounded by the coils 312f thereof onto the yokes 311.

With reference to FIGS. 4 and 7, the fixing means 314 for fixing a stator assembly 31, which are configured to fix said stator assembly 31 to the frame 2, will now be described. Preferably, the fixing means 314 are made of a non-magnetisable material, for example an aluminum alloy, a titanium alloy, a stainless-steel alloy or plastic.

According to the embodiment shown in FIGS. 4 and 7, the fixing means 314 comprise, for each stator assembly 31, two platforms 314a.

As illustrated in FIG. 4, each platform 314a is arranged at a respective end of the stator assembly 31, in the direction of displacement, and is preferably fixed to the two jaws 313a, 313b of the securing means 313, for example by screwing, bonding or welding. Also preferably, the platforms 314a are arranged between the jaws 313a, 313b and the interaction part 41, in such a way that the platforms 314a allow easy mounting and dismantling of the jaws 313a, 313b encapsulating the yoke 311 and the teeth 312a, 312b while guaranteeing that the correct positioning thereof is maintained. It will be understood, however, that the platforms 314a could be arranged in such a way that the jaws 313a, 313b are arranged between the interaction part 41 and the platforms 314a. It will also be understood that, according to less preferred variants, the fixing means 314 could comprise a single platform 314a for each stator assembly 31, or that each platform 314a could be fixed to only one jaw 313a, 313b.

According to the embodiment shown in FIG. 4, the platforms 314a extend right through the stator assembly 31 in the direction perpendicular to the direction of stacking of the sheets 311a of the yoke 311 and perpendicular to the direction of displacement. It will be understood, however, that each platform 314a could in a variant comprise two parts, each fixed to a respective side of the stator assembly 31.

Moreover, when the securing means 313 do not comprise a jaw 313a, 313b, it will be understood that the fixing means 314 are configured to be fixed to the stator assembly 31, for example directly to the yoke 311, for example by screwing, bonding or welding.

According to the embodiment shown in FIG. 7, the frame 2 comprises fixing holes 2b and elongate fixing holes 2c extending in the direction of displacement. Preferably, the fixing holes 2b and the elongate fixing holes 2c are formed in the casing 2a. However, it should be understood that, when the frame 2 does not comprise a casing 2a, the fixing holes 2b and the elongate fixing holes 2c may be formed in other elements of the frame, for example bars or tubes, or the frame may comprise elements, for example fixing lugs, specially configured to define the fixing holes 2b and the elongate fixing holes 2c.

Ends 314e of the platforms 314a, in the direction perpendicular to the direction of stacking of the sheets 311a of the yoke 311 and perpendicular to the direction of displacement, are configured to be fixed to the frame 2. More particularly, said ends 314e are configured to be inserted into the fixing holes 2b and the elongate fixing holes 2c. It should be understood that the elongate fixing holes 2c have the advantage, with respect to the fixing hole 2b, of allowing an adjustment of the position of the stator assembly 31 in the direction of displacement, to be made. It will therefore be understood that according to a non-preferred variant, the frame 2 may comprise only fixing holes 2b and no elongate fixing holes 2c.

Adjusting the position of the stator assemblies 31 in the direction of displacement, by means of the elongated fixing holes 2c, makes it possible in particular to reduce the expansion forces of the machine 1. In the case of the use of two stator assemblies 31, adjusting the position of one of the stator assemblies 31 is sufficient to reduce the expansion forces of the machine.

According to the embodiment shown in FIG. 4, the fixing means 314 further comprise air gap adjustment screws 314b and air gap wedges 314c.

The air gap adjustment screws 314b are received in holes formed in the jaws 313a, 313b and are configured to allow adjustment of a spacing between the jaws 313a, 313b and the platforms 314a. It should be understood that screwing the air gap adjustment screws 314b increases the spacing between the jaws 313a, 313b and the platforms 314a, and that unscrewing the air gap adjustment screws 314b reduces the spacing between the jaws 313a, 313b and the platforms 314a. It should thereby be understood that the air gap adjustment screws 314b make it possible to adjust the air gap 6 between the teeth 312a, 312b of the stator assemblies 31 and the interaction sub-parts 411 of the interaction part 41.

The air gap wedges 314c are configured to be arranged in recesses 314d formed in the platforms 314a on a face opposite the jaws 313a, 313b, so that the jaws 313a, 313b are in contact with the air gap wedges 314c.

It should be understood that, by combining a change in the number of air gap wedges 314c arranged in each recess 314d and a change in the thickness of the air gap wedges 314c, it is possible to modify the spacing between the jaws 313a, 313b and the platforms 314a.

It should thereby be understood that the use of calibrated air gap wedges 314c, for example 0.1 mm thick, makes it possible to finely adjust the air gap 6 between the teeth 312a, 312b of the stator assemblies 31 and the interaction sub-parts 411 of the interaction part 41.

Such an adjustment of the air gap 6 makes it possible for example to take up manufacturing clearances or else to optimize the value of the air gap 6 following the adjustment of the position of a stator assembly 31 by sliding in the direction of displacement. An adjustment of the air gap 6 then makes it possible in particular to reduce the forces generated in directions perpendicular to the direction of displacement generated due to different air gap values 6 between the interaction part 41 and each stator assembly 31. The orthogonal forces induce friction in the translational guide means 5 and impair the operation of the machine 1. An adjustment of the air gap 6 thereby improves the overall performance of the machine 1.

However, it will be understood that, in a variant, the fixing means 314 may comprise only air gap adjustment screws 314b or only air gap wedges 314c.

FIG. 8 shows a stator assembly 31 according to a variant of the embodiment shown in FIGS. 4 and 5. For said variant, the fixing means 314 are identical to same of the embodiment shown in FIGS. 4 and 7.

A stator assembly 31 according to the embodiment shown in FIG. 8 is identical to a stator assembly 31 according to the embodiment shown in FIGS. 4 and 5 except that same also comprises an additional tooth 312h.

According to such variant, and as has been briefly mentioned hereinabove, one of the jaws 313a, 313b preferably comprises an additional recess 313c, such that the securing means 313 are configured to secure the additional tooth 312h to the yoke 31, in the same way as for the teeth 312a, 312b of the pairs 312 of teeth 312a, 312b.

The additional tooth 312h is arranged in contact with a lateral contact face 311b of the yoke 311 of the stator assembly 31.

Preferably, in order to improve the compactness of the stator assembly 31, the additional tooth 312h is arranged furthest at one longitudinal end of said yoke 311. Else preferably, and still to improve compactness, the stator assembly 31 is configured in such a way that the additional tooth 312h is in contact with the same lateral contact face 311b of the yoke 311 as a tooth 312a, 312b arranged furthest at an opposite longitudinal end of said yoke 311.

The use of an additional tooth 312h makes it possible to break the magnetic symmetry of the stator assembly 31, so that it will be more complicated, or even impossible, for the interaction sub-parts 411 of the secondary assembly 4 to align with the teeth 312a, 312b of the stator assembly 31 after a relative displacement of the secondary assembly 4 with respect to the primary assembly 3, thereby reducing the expansion forces of the machine 1.

It should be specified herein that the dimensions of the additional tooth 312h may be different from the dimensions of the teeth 312a, 312b of the pairs 312 of teeth 312a, 312b, more particularly a thickness in the direction of displacement may be different. However, it should be understood that, preferably, the dimensions of the additional tooth 312h are configured to enable the additional tooth 312h to be secured to the yoke 311 by the securing means 313 of the stator assembly 31.

It should also be understood that the additional tooth 312h can be made from a stack of sheets of magnetisable material or in the form of a monolithic part, for example formed from magnetic powder.

In motor mode, the magnetic interactions between the teeth 312a, 312b of the primary assembly 3 and the interaction sub-parts 411 of the secondary assembly 4 are created by means of the coils 312f surrounding the teeth 312a, 312b which are powered by means of the electrical module 7. As mentioned hereinabove, the secondary assembly 4 can also comprise magnets 413, 414 arranged between the interaction sub-parts 411 in order to reinforce the magnetic interactions. However, the interaction part 41 may also be free of magnets 413, 414 if the interaction sub-parts 411 comprise projections spaced apart in the direction of displacement, the interactions then simply being formed between the teeth 312a, 312b and the projections.

As indicated hereinabove, the machine 1 is preferably configured to allow, for each pair 312 of teeth 312a, 312b, a magnetic looping between the first tooth 312a, the yoke 311 and the second tooth 312b. Moreover, the interaction sub-parts 411 are distributed within the interaction part 41 and the teeth 312a, 312b are distributed along the yokes 311, in such a way that when a pair 312 of teeth 312a, 312b is directly opposite interaction sub-parts 411, then at least one other pair 312 of teeth 312a, 312b of the machine is offset with respect to the interaction sub-parts 411 of the facing interaction part 41. Thereby, the variations of the magnetic fields produced by the coils 312f, linked to the variations of the polyphase alternating power supply, allow a relative displacement of the primary assembly 3 with respect to the secondary assembly 4.

In generator mode, the coils 312f surrounding the teeth 312a, 312b are not powered and thus do not generate a magnetic field. It is thus necessary that magnets 315, 413, 414 are arranged in the machine 1 to generate magnetic fields, so that a relative movement of the secondary assembly 4 with respect to the primary assembly 3 can generate alternating currents in the coils 312f, so that the alternating currents are collected by means of the electrical module 7. As indicated hereinabove, the machine may comprise magnets 315 arranged in the stator assemblies 31, magnets 413, 414 arranged in the interaction part 41, or a combination of magnets 315 arranged in the stator assemblies 31 and magnets 413, 414 arranged in the interaction part 41. The arrangement of magnets 315 only in stator assemblies 31 may be a solution for reducing the quantity of magnets required for the operation of the machine 1, for reducing the weight of the secondary assembly 4, or for reducing the cost of the machine 1.

As for the motor mode, in generator mode, it is necessary that the interaction sub-parts 411 comprise projections if the interaction part 41 is free of magnets 413, 414. In such case, it is also necessary that magnets 315 are arranged in the stator assemblies 31, as shown for example in FIG. 10.

In order to enable the machine 1 to operate with a small pole pitch, the invention also provides for advantageous distribution and spacing of the pairs 312 of teeth 312a, 312b along the yokes 311 of the stator assemblies 31.

Periodicity rules will be presented below with reference to FIG. 9. A machine according to FIG. 1 is considered herein, comprising magnets 413, 414 in the interaction part 41, and an electrical module 7 transmitting a three-phase alternating power supply the three phases of which are respectively denoted A₁, A₂ and A₃, each pair 312 of teeth 312a, 312b being supplied from one of the phases A₁, A₂ and A₃.

As indicated hereinabove, the coils 312f of each pair 312 of teeth 312a, 312b are configured to generate a polarity at the base end 312e, and at the head end 312d respectively, of the first tooth 312a and to generate a polarity opposite the base end 312e, and at the head end 312d respectively, of the second tooth 312b.

Preferably, the coil 312f of the second tooth 312b is wound in the opposite direction to the winding direction of the coil 312f of the first tooth 312a. However, in a variant, it should be understood that the current could be made to flow in an opposite direction in the coil 312 of the second tooth 312b, with respect to the coil 312f of the first tooth 312a, or that the coil 312f of the second tooth 312b could be supplied with a current opposite to the current which supplies power to the coil of the first tooth 312a. It should thus be understood that, for each pair 312 of teeth 312a, 312b, the coil 312f of the first tooth 312a and the coil 312f of the second tooth 312b are supplied with power in opposite directions, supplied with opposite currents or wound in opposite directions.

It should further be understood that, for a tooth 312a, 312b, the notation Aᵢ+ represents a supply of the coil 312f surrounding it from the phase Aᵢ and an opposite winding direction, or an opposite current flow direction, or an opposite current, with respect to the notation Aᵢ−. It should also be understood that for each pair 312, one of the first tooth 312a and the second tooth 312b is denoted Aᵢ+, and the other of the first tooth 312a and the second tooth 312b is denoted Aᵢ−.

If Eₐ is the thickness of a north-south magnet 413, or south-north magnet 414 according to the direction of displacement, and Eₘ is the thickness of an interaction sub-part 411 according to the direction of displacement, and if the pole pitch p is defined as the distance, according to the direction of displacement, between the center of two consecutive interaction sub-parts 411 of the same polarity, then p=2×(Eₐ+Eₘ).

Moreover, as indicated hereinabove, for each pair 312 of teeth 312a, 312b, when the first tooth 312a is directly opposite an interaction sub-part 411, the second tooth 312b is directly opposite another interaction sub-part 411 of opposite polarity, so that for a given pair 312, the tooth Aᵢ+ is offset by εₚ×(p/2) in the direction of displacement with respect to the tooth Aᵢ−, with εₚ=±1 as a function of the given pair 312 of teeth 312a, 312b.

Preferably, for each stator assembly 31, the teeth 312a, 312b are arranged along the yoke 311 in such a way that for each given pair c, composed of a tooth A₁+ and a tooth A₂+, of another pair 312 of teeth 312a, 312b, there is a relative integer k_{c}, and that the tooth A₁+ is offset by k_{c}×p+(⅓)×p in the direction of displacement with respect to tooth A₂+; and that for each given pair c', consisting of a tooth At-and of a tooth A₂−, of another pair 312 of teeth 312a, 312b, there is a relative integer k_{c}′, and that the tooth A₁− is offset by k_{c}′×p+(⅓)×p in the direction of displacement with respect to the tooth A₂−.

More preferably, for each stator assembly 31, the teeth 312a, 312b are arranged along the yoke 311 in such a way that for each given pair d, composed of a tooth A₁+ and a tooth A₃+, of another pair 312 of teeth 312a, 312b, there is a relative integer n_{d}, and that the tooth A₁+ is offset by n_{d}×p+(⅔)×p along the direction of displacement with respect to the tooth A₃+; and that for each given pair d′, composed of a tooth A₁− and of a tooth A₃−, of another pair 312 of teeth 312a, 312b, there is a relative integer n_{d}′, and that the tooth A₁− is offset by n_{d}′×p+(⅔)×p in the direction of displacement with respect to the tooth A₃−.

Still preferably for each stator assembly 31, the teeth 312a, 312b are arranged along the yoke 311 in such a way that for each given pair e, composed of a tooth A₁+ and a tooth A₂−, of another pair 312 of teeth 312a, 312b, there exists a relative integer kₑ, so that the tooth A₁+ is offset from the tooth A₂− by kₑ×p+(⅓)×p+εₑ×(p/2), with εₑ=±1 as a function of the given couple e.

Else preferably, for each stator assembly 31, the teeth 312a, 312b are arranged along the yoke 311 in such a way that for each given pair f, composed of a tooth A₁+ and a tooth A₃−, of another pair 312 of teeth 312a, 312b, there is a relative integer n_{f}, so that the tooth A₁+ is offset from the tooth A₃− by n_{f}×p+(⅔)×p+ε_{f}×(p/2), with ε_{f}=±1 as a function of the given pair f.

FIG. 9 shows a possible distribution for the teeth 312a, 312b along the yoke 311 for a machine comprising six pairs 312, namely A₁+/A₁−; A₂−/A₂+; A₃+/A₃−, then A₁−/A₁+; A₂+/A₂−, A₃−/A₃+

A person skilled in the art would understand that the three-phase system described hereinabove could be generalized to a polyphase system with m phases.

In such case, preferably, for each stator assembly 31, the teeth 312a, 312b are arranged along the yoke 311 in such a way that for each given pair h, composed of a tooth Aₗ+ and a tooth A_{l+z}+, of another pair 312 of teeth 312a, 312b, there is a relative integer kₕ, and the tooth Aᵢ+ is offset by kₕ×p+(z/m)×p in the direction of displacement with respect to the tooth A_{i+z}+, with m being an integer greater than or equal to 2, and for i an integer between 1 and m-1 and z an integer between 1 and m-i. should be understood that, for a given pair 312, the tooth Aᵢ+ is also offset by εₚ×(p/2) in the direction of displacement with respect to tooth Aᵢ− , with εₚ=±1 as a function of the given pair 312 of teeth 312a, 312b.

According to the invention, expansion forces refer to forces which, in the absence of current in the coils 312f, are exerted in the direction of displacement, between the interaction part 41 and the teeth 312a, 312b of the stator assemblies 31.

1. A linear movement electrical machine (1) with linear movement in a direction of displacement, configured to operate according to at least one of a motor mode, in which electrical energy is transformed into mechanical energy of linear movement type in the direction of displacement, and a generator mode, in which mechanical energy of the linear movement type in the direction of displacement is transformed into electrical energy, said electrical machine comprising:
a primary assembly (3) comprising at least one stator assembly (31) configured to be fixed to a frame (2);
a secondary assembly (4) configured to move relatively with respect to the primary assembly (3) in the direction of displacement, the secondary assembly (4) comprising an interaction part (41) within which a plurality of interaction sub-parts (411) are distributed in the direction of displacement, and at least one shaft (42), which is integral with the interaction part (41) and extends in the direction of displacement,
each stator assembly (31) being arranged opposite the interaction part (41) of the secondary assembly (4);
translational guide means (5) configured to guide the relative movement of the secondary assembly (4) with respect to the primary assembly (3); and
an electrical module (7) ;
each stator assembly (31) comprising:
a yoke (311) which has at least two lateral contact faces (311b), defined on either side of an axis parallel to the direction of displacement and passing through the centre of the yoke (311);
at least two pairs (312) of teeth (312a, 312b), each tooth (312a, 312b) having a head end (312d) configured to come into contact with a lateral contact face (311b) of the yoke (311) and a base end (312e), opposite the head end (312d), configured to be oriented towards the interaction part (41) of the secondary assembly (4), such that an air gap (6) is formed between the teeth (312a, 312b) and the interaction sub-parts (411) of the secondary assembly (4) and that, upon relative movement of the secondary assembly (4) with respect to the primary assembly (3), an interaction sub-part (411) of the secondary assembly (4) moves relatively parallel to the surface formed by the base ends (312e) of the teeth (312a, 312b) of the opposing stator assembly (31), the pairs (312) of teeth (312a, 312b) being spaced apart along the yoke (311) in the direction of displacement, the teeth (312a, 312b) of a pair (312) of teeth (312a, 312b) being arranged diagonally along the yoke (311) such that, for each pair (312) of teeth (312a, 312b), a first tooth (312a) is in contact with a lateral contact face (311b) of the yoke (311) and a second tooth (312b) is in contact with another lateral contact face (311b) of the yoke (311), a coil (312f) surrounding each tooth (312a, 312b) around a body section (312g) between the head end (312d) and the base end (312e), and each tooth (312a, 312b) being configured to interact magnetically with opposing interacting sub-parts (411) of the opposing secondary assembly (4);
securing means (313) configured to be able to secure the teeth (312a, 312b) to the yoke (311), the securing means (313) being configured such that at least one of the following conditions is satisfied:
a) for at least one stator assembly (31), the securing means (313) comprise at least one resin-type material configured to encapsulate the teeth (312a, 312b) on the yoke (311);
b) for at least one stator assembly (31), the securing means (313) comprise two jaws (313a, 313b), arranged on either side of the yoke (311), configured to secure the teeth (312a, 312b) to the yoke (311), each jaw (313a, 313b) comprising at least one plate, a first jaw (313a) being intended to receive the first teeth (312a) of the pairs (312) of teeth (312a, 312b) and a second jaw (313b) being intended to receive the second teeth (312b) of the pairs (312) of teeth (312a, 312b), and both jaws (313a, 313b) being configured to be made integral with each other so as to bring the teeth (312a, 312b) and the yoke (311) into contact;
c) for at least one stator assembly (31), at least one of the teeth (312a, 312b) is welded to the yoke (311);
d) for at least one stator assembly (31), at least one of the teeth (312a, 312b) is bonded to the yoke (311);
e) for at least one stator assembly (31), the yoke (311) comprises a groove, extending in the direction of displacement, and the teeth (312a, 312b) comprise projections configured to engage the groove, or vice versa; and
fixing means (314) configured to fix the stator assembly (31) to the frame (2);
the linear movement electrical machine (1) further comprising at least one of magnets (413, 414) arranged between interaction sub-parts (411) of the interaction part (41) of the secondary assembly (4), and magnets (315) arranged between the teeth (312a, 312b) and the yoke (311) of at least one stator assembly (31);
in motor mode, the electrical module (7) is configured to transmit a polyphase AC supply to the coils (312f) so as to generate time-varying magnetic fields, each coil (312f) being configured and powered to generate a magnetic polarity at the base end (312e) of the tooth (312a, 312b) that it surrounds and to generate an opposite magnetic polarity at the head end (312d) of the tooth (312a, 312b) that it surrounds, and the coils (312f) of each pair (312) of teeth (312a, 312b) being configured to generate a polarity at the base end (312e), respectively at the head end (312d), of the first tooth (312a) and to generate an opposite polarity at the base end (312e), respectively at the head end (312d), of the second tooth (312b), so as to create a transverse magnetic loop between said first tooth (312a), the yoke (311) and said second tooth (312b), and
the coils (312f) of each pair (312) of teeth (312a, 312b) being configured and powered such that the produced magnetic fields vary as a function of variations in the polyphase AC supply so as to produce a relative displacement of the secondary assembly (4) with respect to the primary assembly (3);
in generator mode, the electrical module (7) is configured to recover electrical currents generated, in the coils (312f) surrounding the teeth (312a, 312b) of the primary assembly (3), by magnetic interactions formed between the interaction part (41) of the secondary assembly (4) and the teeth (312a, 312b) of the primary assembly (3).

2. The linear movement electrical machine (1) of claim 1, characterized in that, for at least one tooth (312a, 312b), a projected area of the base end (312e) onto the interaction part (41) is greater than a projected area of the body section (312g) onto the interaction part (41).

3. The linear movement electrical machine (1) according to claim 1 when condition b) is satisfied, characterized in that each jaw (313a, 313b) comprises at least as many recesses (313c) as there are pairs (312) of teeth (312a, 312b), each recess (313c) being configured to be able to receive a tooth (312a, 312b), each jaw (313a, 313b) further comprising locking means configured to lock each tooth (312a, 312b) in the recess (313c) in which it is received.

4. The linear movement electrical machine (1) according to claim 3, characterized in that the locking means comprise at least one wedge (313d) configured to be arranged in a recess (313c) and to be able to be displaced in said recess (313c), along the tooth (312a, 312b) received in said recess (313c), in order to lock said tooth (312a, 312b) in said recess (313c).

5. The linear movement electrical machine (1) according to claim 3 or according to claim 4, characterized in that the dimensions of at least one of the recesses (313c) receiving a tooth (312a, 312b) are chosen to allow adjustment of the position of the tooth (312a, 312b) received in said at least one recess (313c) along the yoke (311) of said at least one stator assembly (31), in the direction of displacement, by inserting a wedge in said at least one recess (313c), for example to reduce the expansion forces of the machine.

6. The linear movement electrical machine (1) according to any one of claims 3 to 5, characterized in that at least one of the recesses (313c) receiving a tooth (312a, 312b) is extended by at least one through hole (313f) configured to receive a screw (313g) able to apply a pressure on the tooth (312a, 312b) received in said recess (313c), so as to improve a contact between said tooth (312a, 312b) and said yoke (311).

7. The linear movement electrical machine (1) according to any one of claims 1 to 6, characterized in that, for at least one stator assembly (31), the fixing means (314) comprise at least one platform (314a), each platform (314a) being fixed both to the frame (2) and the at least one stator assembly (31).

8. The linear movement electrical machine (1) according to claim 7, characterized in that the at least one stator assembly (31) further comprises at least one of air gap adjustment screws (314b) configured to allow a change in a spacing between the at least one platform (314a) and the at least one jaw (313a, 313b), and air gap wedges (314c) arranged between the at least one platform (314a) and the at least one jaw (313a, 313b), so as to allow adjustment of the air gap (6) between the teeth (312a, 312b) of said at least one stator assembly (31) and the opposing interaction sub-parts (411), by at least one of changing the number of air gap wedges (314c) and changing the thickness of the air gap wedges (314c).

9. The linear movement electrical machine (1) according to any one of claims 1 to 8, characterized in that the interaction part (41) of the secondary assembly (4) comprises a plurality of sheets (411a, 411b) which are stacked in the direction of displacement and are joined together, and supports (412) which extend in the direction of displacement, at least some sheets (411b) comprising protuberances (411c), and the supports (412) being configured to engage with the protuberances (411c) in order to ensure the mechanical strength of the secondary assembly (4).

10. The linear movement electrical machine (1) according to any one of claims 1 to 9, characterized in that at least one cavity (415), extending in the direction of displacement, is formed in the central part of the interaction part (41) of the secondary assembly (4), so as to limit a magnetic short circuit in the interaction part (41).

11. The linear movement electrical machine (1) according to any one of claims 1 to 10, characterized in that the interaction sub-parts (411) comprise projections made of a material able to be attracted by a magnetic field, projecting towards opposing teeth (312a, 312b) of the primary assembly (3).

12. The linear movement electrical machine (1) according to any one of claims 1 to 11, wherein magnets (413, 414) are arranged between interaction sub-parts (411) of the interaction part (41) of the secondary assembly (4), characterized in that the interaction sub-parts (411) are pole masses, made of magnetisable material, magnetised by magnets (413, 414) arranged between each pole mass.

13. The linear movement electrical machine according to any one of claims 1 to 12, characterized in that at least one stator assembly (31) further comprises an additional tooth (312h) arranged in contact with a lateral contact face (311b) of the yoke (311) of said at least one stator assembly (31), said at least one stator assembly (31) being configured such that said additional tooth (312h) makes it possible to break a magnetic symmetry of said at least one stator assembly (31), for example to reduce the expansion forces of the machine (1).

14. The linear movement electrical machine (1) according to any one of claims 1 to 13, characterized in that at least one stator assembly (31) is fixed to the frame (2) by means of fixing means (314) so as to be able to be moved, during an adjustment phase of the machine (1), by sliding in the direction of displacement in order to allow its position to be adjusted, for example to reduce expansion forces of the machine (1).

15. The linear movement electrical machine (1) according to any one of claims 1 to 14, characterized in that at least one tooth (312a, 312b) comprises a plurality of flat sheets (312c) stacked in a stacking direction parallel to the direction of displacement.

16. The linear movement electrical machine according to any one of claims 1 to 15, characterized in that at least one yoke (311) comprises a plurality of sheets (311a) stacked in a stacking direction perpendicular to a first axis, parallel to the direction of displacement and passing through the centre of the interaction part (41) of the secondary assembly (4), and to a second axis, which corresponds to the axis parallel to the direction of displacement and passing through the centre of said at least one yoke (311).

17. The linear movement electrical machine (1) according to any one of claims 1 to 16, characterized in that at least one of a tooth (312a, 312b) and a yoke (311) is in the form of a part formed from magnetic powder.

18. The linear movement electrical machine (1) according to any one of claims 1 to 17, characterized in that the translational guide means (5) comprise at least one of a ball-bearing glide (51a) arranged between the primary assembly (3) and the secondary assembly (4), a ball-bearing glide arranged between the frame and the secondary assembly (4), and a translational shaft guide element (52), for example a linear plain bearing or a linear ball bearing, arranged between a shaft (42) and the frame (2).

19. The linear movement electrical machine (1) according to any one of claims 1 to 18, characterized in that it further comprises a casing (2a) configured to contain, at any instant of use, at least the primary assembly (3) and the interaction part (41) of the secondary assembly (4).

20. The linear movement electrical machine according to any one of claims 1 to 19, characterized in that the offsets between the teeth, in the direction of displacement, comply with the following conditions for a polyphase supply consisting of m phases, the successive phases of which are denoted Ai with i being an integer between 1 and m, for each pair (312) of teeth (312a, 312b), the coils (312f) being supplied from one of the phases Ai and one of the first tooth (312a) and the second tooth (312b) being denoted Ai+ and the other of the first tooth (312a) and the second tooth (312b) being denoted Ai−; Ai− having, with respect to Ai+, one of an opposite direction of winding of its coil (312f), an opposite direction of current flow in its coil (312f), and supply of its coil (312f) with an opposite current; the pole pitch being noted p:
for each given pair h, composed of a tooth Ai+ and a tooth Ai+z+, of another pair (312) of teeth (312a, 312b), there is a relative integer kh, and the tooth Ai+ is offset by kh×p+(z/m)×p in the direction of displacement with respect to the tooth Ai+Z+, with m being an integer greater than or equal to 2, and for i an integer between 1 and m-1 and z an integer between 1 and m-i; and
for each given pair (312) of teeth (312a, 312b) comprising a tooth Ai+ and a tooth Ai−, an offset between Ai+ and Ai− in the direction of displacement is equal to εp×(p/2), with εp being equal to 1 or −1 according to the given pair (312).
